(19) United States
(12) Patent Application Publication
(10) Pub. No.: US 2006/0289247 A1
(43) Pub. Date: Dec. 28, 2006

(54) Elevator system

(76) Inventor: Alexander Powell, Brooklyn, NY (US)

Correspondence Address: Dwayne L Bentley;Law Office of Dwayne L Bentley, 16 Court Street, Suite 1112, Brooklyn, NY, 11124, US

(21) Appl. No.: 10/525,548

(22) PCT Filed: Feb. 17, 2005
(86) PCT No.: PCT/US05/05995

§ 371 Date: Oct. 27, 2005

(51) Int. Cl. B66B 7/00

(52) U.S. Cl. 187/414

(57) ABSTRACT

The present invention provides an elevator. The elevator includes a car having a plurality of side walls coupled to a guide rail. A plurality of wall structures is connected to the guide rail, where a plurality of cavities is located in between the plurality of wall structures and the plurality of side walls. The plurality of wall structures includes a plurality of air outlets, where the air outlets are configured to receive air. The cavities are configured to trap air received from the air outlets and force the air through a cylinder connected to the plurality of wall structures, where the car utilizes the air to produce electricity.

### FIELD OF THE INVENTION

This invention relates to a method for utilizing an elevator system to produce power. More particularly, the present invention relates to the utilization of air pressure generated by the elevator system to provide electricity.

### BACKGROUND OF THE INVENTION

Generally when a person enters any type of building there are various ways for the person to be transported from one floor to another. A person may use the stairs, escalator or elevators to ascend or descend from one floor to another in a building. Usually, the elevator is the preferred mode of transportation in a building.

Typically, there are two types of elevators a cable elevator and a hydraulic elevator. The cable elevator includes an electric motor that is rotatively connected with a drum. The drum has a traction cable wrapped over the other end of the cable is attached to an elevator car. The other end of the cable is attached to a counterweight. The elevator car and counterweight are moved up and down opposite one another by rotation of the drum. A cable elevator requires a structural support which can hold the electric motor and drum on top of a building structure. For the hydraulic elevator, it does not require as much structural support of the elevator shaft as the cable elevator. Also, the hydraulic elevator does not require an overhead motor. In the common type of hydraulic elevator, a powering cylinder is positioned at a subterranean level. Slidably and sealably mounted within the cylinder is a piston. The piston is sealed by a jack head which is mounted on top of the cylinder. The piston is made from a hollow piece of steel which has an exterior wall which is highly polished. To move the elevator car, pressurized fluid is pumped into the cylinder to extend the piston upwards. To lower the elevator car, pressurized fluid is released from the cylinder.

The aforementioned elevators are used in virtually all buildings, but these elevators have only been used to transport people or products from one floor to another. However, these elevators have not been used to provide a cost-effective and environmentally safe means to provide power to the building that houses the elevator.

Therefore, there is a need for an elevator system that is capable of producing electricity in a cost-effective and environmentally safe manner.

### BRIEF SUMMARY OF THE INVENTION

The present invention has been accomplished in view of the above-mentioned technical background, and it is an object of the present invention to provide a cost-effective and safe means to provide electricity by utilizing air pressure produced by the operation of a typical elevator system.

In a preferred embodiment of the invention an elevator is disclosed. The elevator includes a car having a plurality of side walls coupled to a guide rail. A plurality of wall structures is connected to the guide rail, where a plurality of cavities is located in between the plurality of wall structures and the plurality of side walls. The plurality of wall structures includes a plurality of air outlets, where the air outlets are configured to receive air. The cavities are configured to trap air received from the air outlets and force the air through a cylinder connected to the plurality of wall structures, where the car utilizes the air to produce electricity.

In another preferred embodiment of the invention, an elevator system is disclosed. The system includes a car, where the car is configured to move from one level to another. A cylinder is connected to the car, where the cylinder is configured to receive air from an area surrounding the car as it moves. A storage tank is coupled to the cylinder, where the storage tank is configured to receive the air, where the storage tank includes an air pressure sensor to measure the air received. The air pressure sensor is coupled to a processor, where the air pressure sensor is configured to transmit measurements of the air in the storage tank. The processor is configured to determine if the measured air is equivalent to an air level stored in the processor.

In yet another preferred embodiment of the invention, a method for utilizing an elevator system is disclosed. A car of the elevator system moves from one level to another. As the car moves, air is pumped from the areas surrounding the car. The air being pumped is measured and transmitted to a processor. Next, there is a determination if the measured air is equivalent to a stored air level.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 illustrates an embodiment of an elevator in accordance with the invention;

FIG. 2 illustrates another embodiment of an elevator in accordance with the invention;

FIG. 3 is a block diagram of an embodiment of an elevator system in accordance with the invention;

FIG. 4 is a flow chart that depicts a method of how the elevator system of FIG. 3 is employed in accordance with the invention;

FIG. 5 is another flow chart that depicts a method of how the elevator system of FIG. 3 is employed in accordance with the invention; and

FIG. 6 is a block diagram of another embodiment of an elevator system in accordance with the invention.

### DETAILED DESCRIPTION OF THE INVENTION

The presently preferred embodiments of the invention are described with references to the drawings, where like components are identified with the same numerals. The descriptions of the preferred embodiments are exemplary and are not intended to limit the scope of the invention.

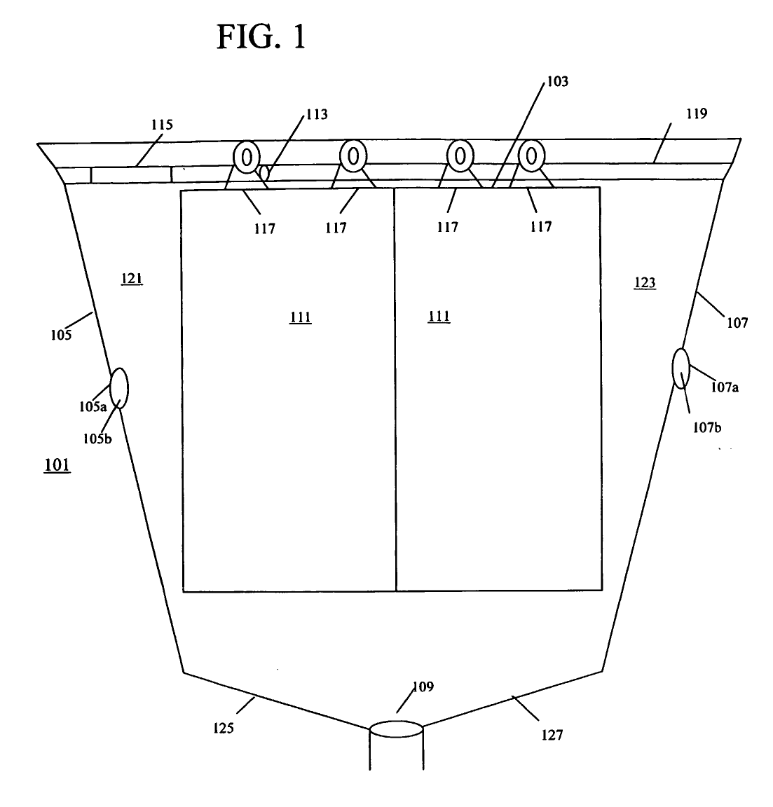

FIG. 1 illustrates an elevator. Elevator 101 includes a car 103, wall structure 105, wall structure 107, funnel connector 125, funnel connector 127 and a cylinder 109. Car 103 includes a pair of center opening doors 111 and a door operating system 113. In an alternative embodiment, the center operating doors 111 may be side opening doors and/or telescoping door systems. Door operating system 113 includes an electronic control system 115 and a plurality of motorized door rollers 117 that are engaged with a door guide rail 119. The utilization of the door operating system 113 permits the roof of the car 103 to remain clear of equipment, such as convention door operators that are mounted to the roof of typical elevator cars. In yet another embodiment, motorized rollers 117 may be replaced with motorized pulleys mounted on the car 103 and engaged with the doors via a traction cord, or linear motor door systems.

Next to the motorized rollers 117, there are wall structures 105 and 107, which are utilized to trap air in cavities 121 and 123 on side walls of the car 103 as the car descends from one level to another. Wall structures 105 and 107 include outlets 105a and 107a. Outlets 105a and 107a are designed to receive air along the side of the car 103 in cavities 121 and 123 as car 103 descends to another level. These outlets 105a and 107a include typical air-flaps 105b and 107b that are capable of opening when the car descends to another level and dosing when the car arrives at the next level. For example, if the elevator is at floor 16 the air flaps 105a and 107a will open to allow the outlets 105a and 107a to receive air, then the air flaps 105b and 107b will close when the car 103 stops at floor 14. As the car 103 travels from one floor to another air becomes trapped in cavities 121 and 123 by wall structures 105 and 107, where the air is directed by funnel connectors 125 and 127 to go through cylinder 109.

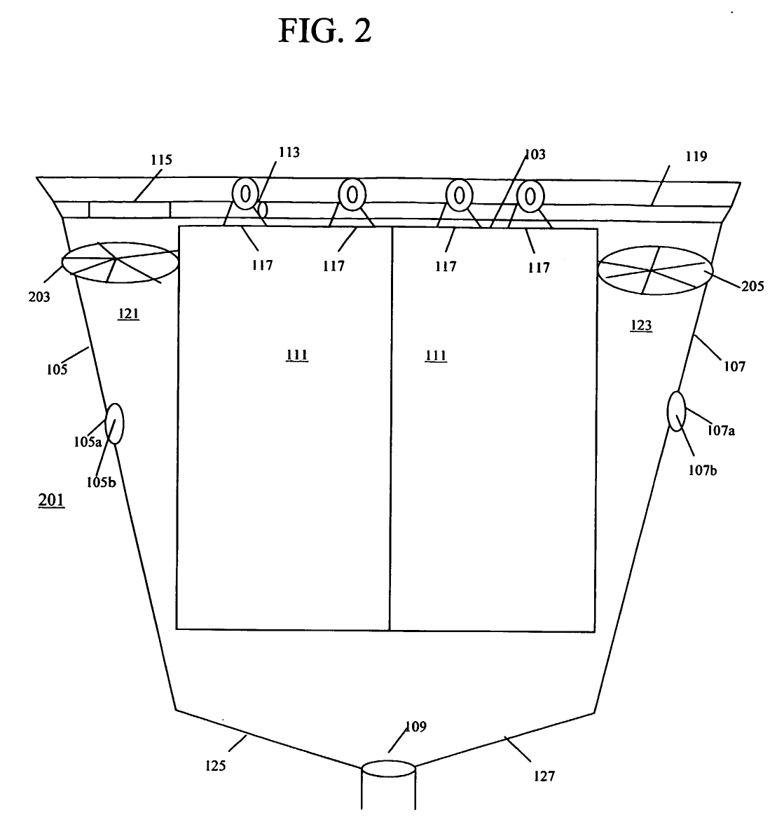

FIG. 2 is an illustration of another elevator. Elevator 201 includes all of the components of FIG. 1. However, elevator 201 also includes fans 203 and 205 connected to the door operating system 113. Fans 203 and 205 provide additional air pressure on the sides of car 103 to force the air that is received through outlets 105 and 107, which is trapped in cavities 121 and 123, to be directed down through funnel connectors 125 and 127 through cylinder 109, as described above. For example, when the car 103 descends from floor 13 to floor 11 air flows through outlets 105a and 107a as the car 103 descends. When the air is in the cavities 121 and 123 the fans 203 and 205 controls the air flow to force the air to go towards the cylinder 109. In another embodiment, fans 203 and 205 are replaced with an air conditioner or any standard device utilized to direct air flow.

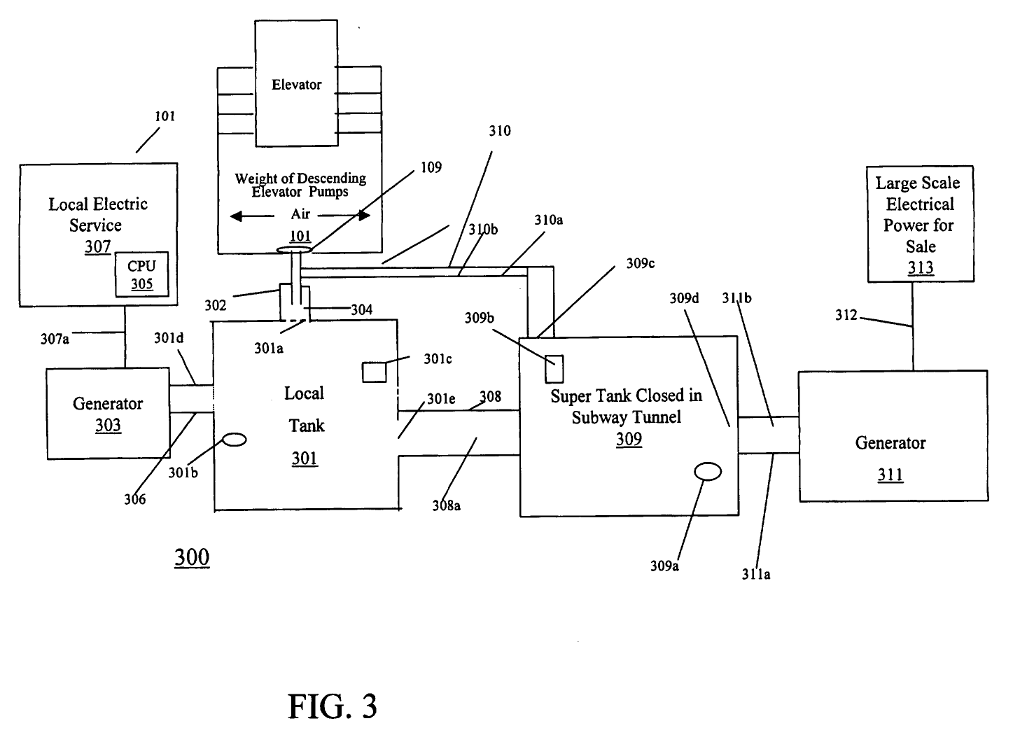

FIG. 3 is a block diagram of an elevator system. Elevator system 300 includes: elevator 101 (FIG. 1), a local tank or storage tank 301, a generator 303, a central processing unit 305 in a local electric service area 307, cylinder 109 (FIG. 1), pump 302, cylinder 306, cylinder 308, pump 308 a, a super tank closed in a subway tunnel 309, pressure sensor 309a, pump 309b, a large generator 311 and a large scale electrical power source 313. The super tank closed in a subway tunnel 309 also may represent a large container that is able to hold large amounts of pressurized air.

Elevator 101 is connected by a wireless connection to a central processing unit (CPU) 305. In yet another embodiment, the wireless connection may be a land access network (LAN), a wireless local network, a wide area network (WAN), a metropolitan area network, a virtual area network, an Ethernet link, a satellite link, cable, cellular, twisted-pair, fiber-optic or any network that is able to facilitate the transfer of data between computers or communication devices. In yet another embodiment of the invention, the wireless connection may be an actual wire connection between elevator 101 and CPU 305.

Central processing unit 305 may be a typical computer that includes a memory, processor, storage area, input device and all of the typical components associated with a computer. This central processing unit is housed at the local electrical service area 307, but it may also be located at the large scale electrical power source 313 or some other accessible area that allows the building personnel or any personnel the ability to monitor it and/or control the CPU 305. In addition, the central processing unit (CPU) 305 includes a software program or algorithm that is capable of receiving information from the components pump 302, an air pressure sensor 301b, pump 301c, generator 303, super tank 309, large generator 311 and large scale electrical power source 313, then processes the information to activate the components to perform a specific action. In addition, the CPU 305 includes a database or processor of preferred levels of air pressure required to activate the generator 303 and large scale generator 309. For example, the processor in CPU 305 includes a requirement of at least 300 pounds square inch (psi) that is needed to activate the generator 303 to generate electricity and a requirement of at least 1000 psi to activate the large scale generator 311 to generate electricity. The amount of pressure required by the CPU 305 to generate electricity in generator 303 and generator 309 is determined by the operator of the CPU 305 or any entity that controls how pressurized air from elevator or car 101 will generate electricity.

When the elevator 101 begins to descend to another floor, the door operating system 113 (FIG.1) transmits a communication to the CPU 305 through a wireless connection that the elevator 101 is descending. When the elevator begins to descend, move or travel then the cylinder 109 receives air that is forced to move based on the weight or mass of the elevator 101 that traps air below or above elevator 101 by a typical device that trapping mechanism that traps air below or above a typical elevator. Also, as the elevator descends or ascends the cavities 121 and 123 transfer air to cylinder 109. The air is transferred through pump 302 connected to the cylinder 109 to a pressure space 304. The pump 302 pumps the air through an opening 301a in the storage tank 301, which sends this transfer of pressure communication through a wireless connection from storage tank 301 to CPU 305. This opening 301a closes after it receives the air from car 101 or cylinder 109.

Storage tank 301 includes an air pressure sensor 301b, pump 301c and another opening 301d. Air pressure sensor 301b measures the amount of air pressure in the storage tank 301. For example, if there is at least 300 pounds square inch (psi) measured by the air pressure sensor 301b in the storage tank 301, then this air pressure measurement is transmitted from a wireless connection at the local tank 301 to the CPU 305 When CPU 305 receives the communication it checks with its processor to determine if this is the level needed to activate generator 303. After CPU 305 makes the confirmation that the measured air is equivalent to the amount of air needed to activate the generator 303, then CPU 305 activates pump 301c to pump the air out of storage tank 301 through opening 301d. This air is transferred through cylinder 306 to the generator 303. In this embodiment, at least 300 psi is the level utilized to activate the generator 303, but any standard amount of air pressure as defined by an operator may be utilized to generate electricity in a generator or motor.

If the air pressure sensor 301b measures that the amount of air pressure in the storage tank is less than 300 psi, then this measurement is also transmitted to CPU 305. CPU 305 compares it with the selected level required to activate the generator to confirm that it has not reach this level, then CPU 305 instructs openings 301a and opening 301d to close until more air pressure is delivered from the movement of the elevator 101.

When the air or air pressure is at least 300 psi, then the CPU 305 forces the air to be pumped by pump 301c through cylinder 306 to the generator 303 to produce electricity. Generator 303 is connected by a wireless connection to CPU 305 that transmits the amount of power produced by generator 309. For example, the air pressure of 300 psi may enable the generator 309 to produce 30 volts of electricity. This air is utilized in the standard way to enable the generator 309 to produce electricity by utilizing air or air pressure. The generator 303 may also be a typical motor. In another embodiment of the invention, the generator 303 may be an electric company that receives air pressure from the elevator 101 that later utilizes the air pressure with a generator or motor to produce electricity.

After the electricity is produced at the generator 303, then the electricity may be transferred by a typical wire connection 303a or a wireless connection to the local electrical service area 307 or a control room to supply power to the building the elevator 101 is housed. Wireless connection between local electric service 307 and CPU 305, provides CPU 305 with information about how the local electrical service is operating, such as electricity supply and pertinent information associated with a supply room or an electric service. In another embodiment, the generator 303 and local electrical service 307 may be housed in the same area.

In another embodiment, when the local tank 301 receives air pressure from elevator 101, this air pressure is measured by the air pressure sensor 301b. When the air pressure sensor 301b measures the air pressure, this measurement is transmitted wirelessly to CPU 305. At CPU 305, the air pressure received from air pressure sensor 301b is compared to see if it is at least 300 psi. If this air pressure is not at least 300 psi, then the air pressure is pumped out by pump 308a through cylinder 308 to the super tank 309 that stores the air pressure. The super tank 309 repeatedly stores air pressure received from local tank 301 while an air pressure sensor 309a measures the air pressure and transmits it wirelessly to the CPU 305 to determine if the 300 psi threshold level has been reached. When the 300 psi threshold level is reached as the amount of air pressure stored from the received air pressure from local tank 101, then the air pressure is pumped out by pump 309b through cylinder 308 and pump 308 through pump 3017d and cylinder 306 to generator 303. Generator 303 operates as stated above to generate electricity that is transferred by wire connection 307a to local electric service 307.

In yet another embodiment of the invention, elevator 101 represents a plurality of elevators that may number in the hundreds, thousands, millions or more. As the elevator 101 descends, then the cylinder 109 receives air from the elevator 101 as stated above. The air is transferred through pump 310a connected to the cylinder 109 to a pressure space 310b. Pump 310a pumps the air through an opening 309d at super tank 309, which sends this transfer of pressure communication through a wireless connection from super tank 309 to CPU 305. This opening 309d closes after it receives the air from car 101 or cylinder 310. Super tank 309 includes the air pressure sensor 309a, pump 309b and another opening 309d. Air pressure sensor 309a, similar to air pressure sensor 301b measures the air pressure in super tank 309. However, this air pressure sensor 309 operates in two manners. First, this air pressure sensor 309a works in conjunction with air pressure sensor 301b and CPU 305, similar to the way air pressure sensor 301b works with CPU 305 described above, when the level of air pressure sensor 301b received at the local tank is lower than 300 psi as the super tank 309 stores air until air pressure sensor 309a reaches the level of 300 psi, then pump 309b pumps the air back to local tank 301. Second, the air pressure sensor 309a works with cylinder 310 and CPU 305, similar to the way air pressure sensor 301b works with CPU 305 described above, to determine if at least 1000 psi air pressure is received by super tank 309. If at least 1000 psi air pressure is received at super tank 309 as determined by air pressure sensor 309a and CPU 305, then pump 309b pumps the air pressure to large scale generator 311, which operates similar to generator 303, to generate electricity that is transferred through wire connection 312 to the large scale electrical power source 313.

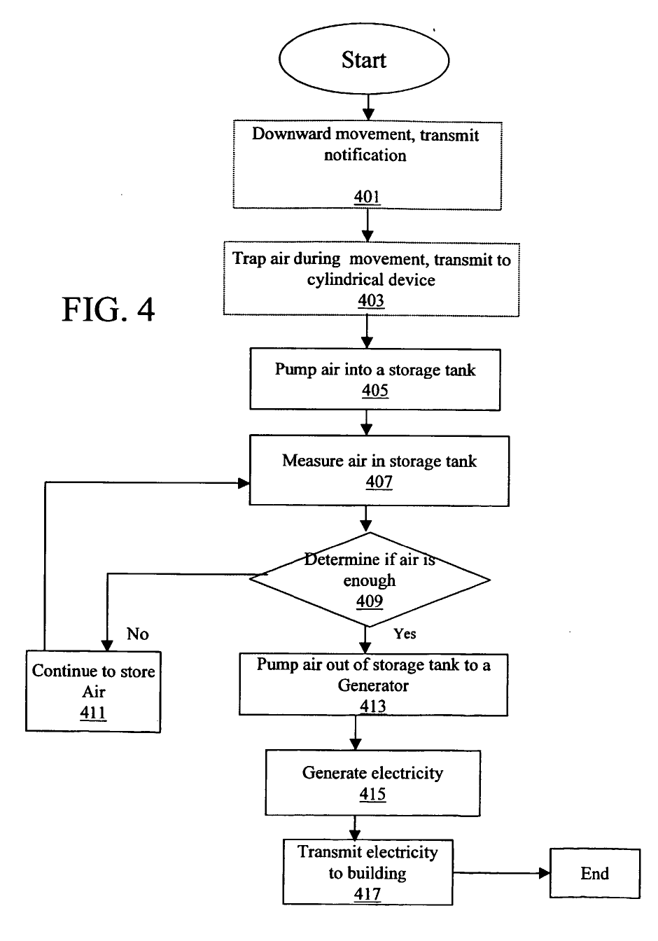

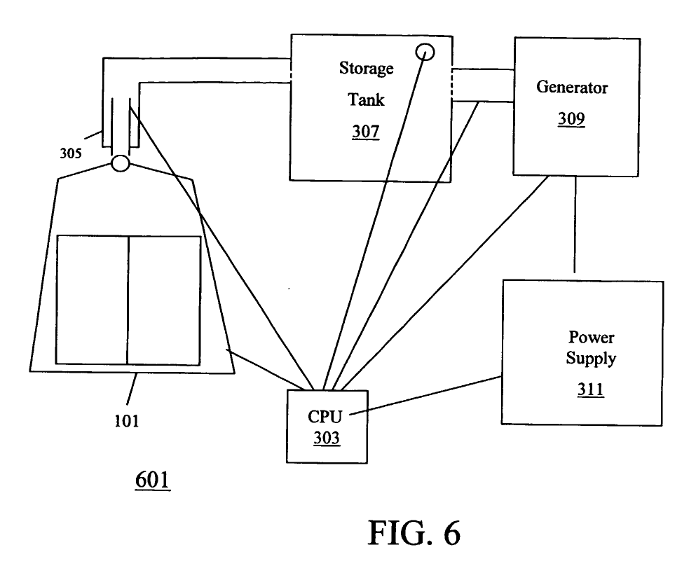

FIG. 4 is a flow chart that depicts an example of how the elevator system may be utilized. At block 401, a person steps into elevator 101 (FIG. 1) and presses the down button. Alternatively, the person may press the up button and the elevator 101 will act similar to as if it is descending as illustrated in FIG. 6. This pressing of the down button is transmitted through the door operating system 113 to the central processing unit (CPU) 305 by utilizing a wireless connection or a wire connection. Optionally, if the elevator 101 includes fans 203 and 205 then the CPU 305 would transmit a communication to the door operating system 113 to start the fans 203 and 205 to blow the air down cavities 121 and 123 as elevator 101 descends to another floor.

At block 403, the elevator 101 begins to descend from one flight to another air flows through outlets 105a and outlets 107a of wall structures 105 and 107, where the air is directed down cavities 121 and 123 towards funnel connectors 125 and 127. When the air reaches the funnel connectors 125 and 127, then the air is pumped by pump 302 (FIG. 3) through cylinder 109. At block 405, pump 303 pumps and compresses the air through opening 301a in the storage tank 301. Pump 302 is connected by wireless connection CPU 305 where the pump 302 communicates that the air is being pumped and compressed into the storage tank 301. When the compressed air reaches the storage tank 301, at block 407, the air pressure sensor 301 b measures the total amount of air in the storage tank when the pump 302 has finished pumping the air.

At block 409, the air pressure sensor 301b utilizes the wireless connection to transmit the measured amount of compressed air pressure in the storage tank 301 to the CPU 305. CPU 305 determines if the amount of air in the storage tank 301 is at least 300 psi or any psi set by an operator needed to generate electricity. At block 411, CPU 305 determines that the measured amount of compressed air in the storage tank 301 does not meet the requirements so CPU 305 instructs the opening 301a and 301d to close until more compressed air is delivered into the storage tank 301 and the compressed air is measured again in block 407. Next, the air pressure from storage tank 301 is transferred by pump 308 and cylinder 308 to super tank 309, where the air is stored until the air pressure sensor 309a with CPU 305 determines that the air pressure has reached 300 psi, then the air pressure is determined to be enough and it is sent to block 409. However, if the CPU 305 determines that the amount of compressed air in the storage tank 301 is at least 300 psi or any psi set by an operator or an equivalent psi utilized by an operator, machine or any typical device utilized to generate electricity, then at block 413 the CPU 305 instructs the pump 301c to pump the air through the opening 301d and cylinder 306 to the generator 303.

At block 415, the generator 303 or motor is able to generate electricity as a response to the compressed air that it received from the cylinder 306. At block 417, the electricity produced by the generator is transmitted to the building that houses the elevator at local electric service area 307 (FIG. 3). In another embodiment, the electricity produced by the generator 303 may be transferred to another building, electric company or any other entity where the electricity may be used to power a building then the process ends. This invention allows a user to produce electricity based on the operation of an elevator 101 that is used in virtually all buildings with more than one floor. It is a cost-effective means for generating electricity.

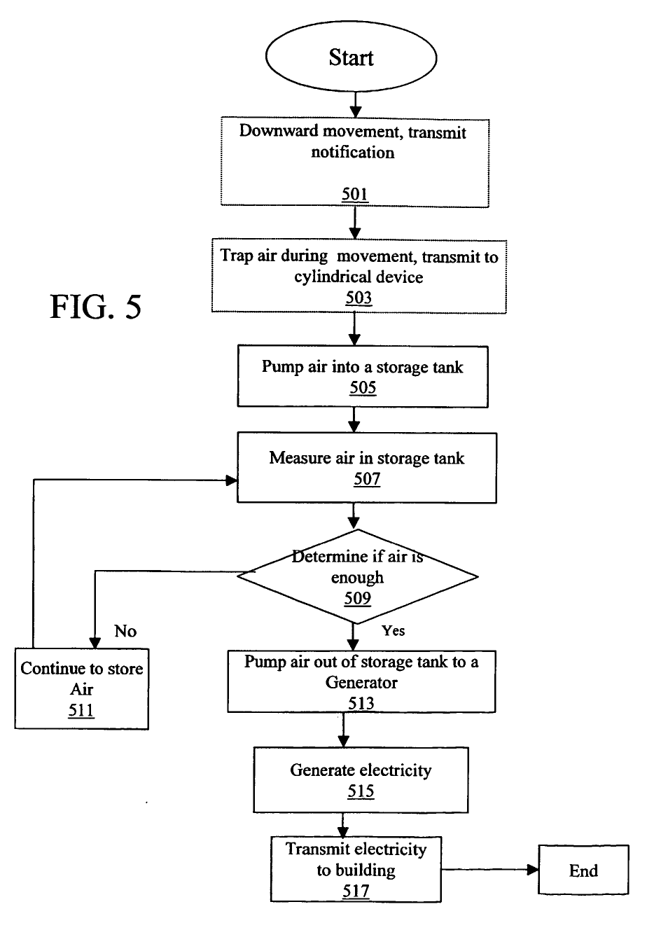

FIG. 5 is a flow chart that depicts another example of how the elevator system may be utilized, where a plurality of elevators are utilized. At block 501, persons step into elevator 101 (FIG. 1) and presses the down button. Alternatively, the persons may press the up button and the elevator 101 will act similar to as if it is descending as illustrated in FIG. 6. This pressing of the down button is transmitted through the door operating system 113 to the central processing unit (CPU) 305 by utilizing a wireless connection or a wire connection. Optionally, if the elevator 101 includes fans 203 and 205 then the CPU 305 would transmit a communication to the door operating system 113 to start the fans 203 and 205 to blow the air down cavities 121 and 123 as elevator 101 descends to another floor.

At block 503, the elevator 101 begins to descend from one flight to another air flows through outlets 105a and outlets 107a of wall structures 105 and 107, where the air is directed down cavities 121 and 123 towards funnel connectors 125 and 127. When the air reaches the funnel connectors 125 and 127, then the air is pumped by pump 310a (FIG. 3) through cylinder 310. At block 505, pump 310a pumps and compresses the air through opening 309c in the super tank 309. Pump 310a is connected by a wireless connection to CPU 305 where the pump 310a communicates that the air is being pumped and compressed into the super tank 309. When the compressed air reaches the storage tank 309, at block 507, the air pressure sensor 309a measures the total amount of air in the storage tank when the pump 310a has finished pumping the air.

At block 509, the air pressure sensor 309a utilizes the wireless connection to transmit the measured amount of compressed air pressure in the super tank 309 to the CPU 305. CPU 305 determines if the amount of air in the storage tank 301 is at least 1000 psi or any psi set by an operator needed to generate electricity. At block 511, CPU 305 determines that the measured amount of compressed air in the super tank 309 does not meet the requirements so CPU 305 instructs the opening 309c and 309d to close until more compressed air is delivered into the super tank 309 and the compressed air is measured again in block 507. However, if the CPU 305 determines that the amount of compressed air in the super tank 309 is at least 1000 psi or any psi set by an operator or an equivalent psi utilized by an operator, machine or any typical device utilized to generate electricity, then at block 513 the CPU 305 instructs the pump 309b to pump the air through the opening 309d, pump 311a and cylinder 311b to the large scale generator 311.

At block 515, the large scale generator 311 or motor is able to generate electricity as a response to the compressed air that it received from the cylinder 311b. At block 517, the electricity produced by the generator 311 is transmitted to the building that houses the elevator at the large scale electrical power source 313 (FIG. 3). In another embodiment, the electricity produced by the generator 311 may be transferred to another building, electric company or any other entity where the electricity may be used to power a building then the process ends. This invention allows a user to produce electricity based on the operation of an elevator 101 that is used in virtually all buildings with more than one floor. It is a cost-effective means for generating electricity.

FIG. 6 is a block diagram of another embodiment of an elevator system. This elevator system 601 is identical to the elevator system 301 (FIG. 3). However, in this elevator system 601 elevator 101 ascends from one floor to the next. As elevator 101 ascends, the air from outlets 105a and 107a (FIG. 1) is transferred through cavities 121 and 123 to the cylinder 109 and operates similar to the elevator system 300 (FIG. 3). This depiction offers another example of how the elevator 101 may be modified for ascending elevators. Since the features of the elevator system 601 are identical to elevator system 300 a reiteration of the components and features will not be discussed herein.

This invention provides a simple means to provide a cost-effective safe means to provide electricity to a building. This system enables a building owner to safely generate power without incurring high bills. Based on the means of entrapping and containing air pressure, this system allows a user to effortlessly produce electricity at a reduced cost. Further, this invention provides an environmentally safe means to produce electricity.

It is intended that the foregoing detailed description be regarded as illustrative rather than limiting and that it be understood that it is the following claims, including all equivalents, which are intended to define the scope of the invention.

1. An elevator comprising:
a car having a plurality of side walls coupled to a guide rail;
a plurality of wall structures connected to the guide rail, wherein a plurality of cavities are located in between the plurality of wall structures and the plurality of side walls; and
wherein the plurality of wall structures includes a plurality of air outlets, wherein the air outlets are configured to receive air; and
the cavities are configured to trap air received from the air outlets and trap air from the weight of the elevator and force the air from the air outlets and air from the weight of the elevator through a cylinder connected to the plurality of wall structures, wherein the car utilizes the air to produce electricity.

2. The elevator of claim 1, wherein the plurality of air outlets includes a plurality of air flaps.

3. The elevator of claim 1, wherein the car is connected to a plurality of fans to force the air to pass through the plurality of cavities.

4. The elevator of claim 1, wherein the plurality of wall structures is coupled to a plurality of funnel connectors configured to allow the air to pass through the cylinder.

5. An elevator system comprising:
a car, wherein the car is configured to move from one level to another;
a cylinder connected to the car, wherein the cylinder is configured to receive air from an area surrounding the car as it moves;
a storage tank coupled to the cylinder, wherein the storage tank is configured to receive the air, wherein the storage tank includes an air pressure sensor to measure the air received;
wherein the air pressure sensor is coupled to a processor, wherein the air pressure sensor is configured to transmit measurements of the air in the storage tank; and
the processor is configured to determine if the measured air is equivalent to an air level stored in the processor.

6. The system of claim 5, wherein the air is transferred to a generator if the measured air is equivalent to the air level stored in the processor.

7. The system of claim 6, wherein the air is transferred through a cylinder connected between the storage tank and the generator.

8. The system of claim 7, wherein the generator is configured to produce electricity in response to receiving the air.

9. A method for utilizing an elevator system:
moving a car from one level to another;
pumping air from an area surrounding the car as it moves;
measuring the air being pumped;
transmitting the measured air to a processor; and
determining if the measured air is equivalent to a stored air level.

10. The method of claim 9, further comprises transmitting the measured air to a generator if the measured air is equivalent to the stored air level.

11. The method of claim 9, further comprises generating electricity at the generator in response to receiving the measured air.

12. An elevator system comprising:
a plurality of cars, wherein the plurality of cars are configured to move from one level to another;
a cylinder connected to the car, wherein the cylinder is configured to receive air from an area surrounding the car as it moves;
a super tank coupled to the cylinder, wherein the super tank is configured to receive the air, wherein the super tank includes an air pressure sensor to measure the air received;
wherein the air pressure sensor is coupled to a processor, wherein the air pressure sensor is configured to transmit measurements of the air in the storage tank; and
the processor is configured to determine if the measured air is equivalent to an air level stored in the processor.

13. The system of claim 12, wherein the air is transferred to a generator if the measured air is equivalent to the air level stored in the processor.

14. The system of claim 13, wherein the generator is configured to produce electricity in response to receiving the air.

15. The system of claim 14, wherein the generator is configured to transfer the electricity to an electrical service
